(19) United States
(12) Patent Application Publication
(10) Pub. No.: US 2025/0077976 A1
(43) Pub. Date: Mar. 6, 2025

(54) REINFORCEMENT LEARNING BASED OPTIMIZATION OF TEXTUAL ARTIFACTS USING GENERATIVE ARTIFICIAL INTELLIGENCE

(71) Applicant: Maplebear Inc., San Francisco, CA (US)

(72) Inventors: Tilman Drerup, Berkeley, CA (US); Jiuyun Zhang, Mountain View, CA (US)

(21) Appl. No.: 18/820,097

(22) Filed: Aug. 29, 2024

Related U.S. Application Data
(60) Provisional application No. 63/535,476, filed on Aug. 30, 2023.

(51) Int. Cl. G06N 20/00

(52) U.S. Cl. CPC G06N 20/00

(57) ABSTRACT

A system generates text artifacts using a machine learned language model. The text artifacts may be provided to a search engine for providing to users along with search results. The system iteratively improves the set of text artifacts by performing the following steps. The system updates the prompt used to generate the text artifacts based on the performance of the text artifacts to obtain a new prompt. The system executes the machine learned language model using the new prompt to generate a new set of text artifacts. The system evaluates the new set of text artifacts to determine performance of each of the new set of text artifacts. These steps are repeatedly performed to improve the set of text artifacts.

### CROSS-REFERENCE TO RELATED APPLICATIONS

This application claims the benefit of U.S. Provisional Application No. 63/535,476, filed on Aug. 30, 2023, which is incorporated by reference herein in its entirety.

### TECHNICAL FIELD

One or more aspects described herein relate generally to machine learned language

models and more specifically to optimizing textual artifacts using reinforcement learning and generative artificial intelligence (AI).

### BACKGROUND

Search engines are used by large numbers of users for searching through documents, websites, and various types of content. Search engines allow text artifacts received from content providers to be provided as search results in response to search queries. Content providers spend significant resources in designing text artifacts or related content that is displayed along with search results. Typically, the text artifacts are manually created by experts using tools designed for generating text artifacts. Designing text artifacts manually is a slow and cumbersome process. Furthermore, manually designed text artifacts are more likely to have errors. Artificial intelligence based techniques such as neural networks may be used for generating text artifacts. Artificial intelligence based techniques may suffer from problems such as hallucinations and may generate poor quality results, for example, text artifacts that may provide a poor description of a content item or project a negative image of the content provider.

### SUMMARY

In accordance with one or more aspects of the disclosure, a system generates text artifacts that may be provided to a search engine for displaying along with search results. The system receives a prompt configured to request a machine learned language model to generate text artifacts. The machine learned language model is executed based on the prompt to generate a set of text artifacts. The system evaluates each of the set of text artifacts to determine their performance. The system iteratively improves the generated text artifacts as follows. The system updates the prompt using data on the performance of each of the set of text artifacts to obtain a new prompt. For example, the new prompt may specify examples of text artifacts having high performance (i.e., having performance metrics that meet or exceed a predetermined threshold) and examples of text artifacts having poor performance (i.e., having performance metrics that fail to meet the predetermined threshold). The system executes the machine learned language model using the new prompt to generate a new set of text artifacts. The system evaluates the new set of text artifacts to determine performance of each of the new set of text artifacts. The system repeatedly performs these steps to improve the text artifacts generated.

According to one or more embodiments, the system generates a prompt requesting the machine learned language model to determine the performance of each of the new set of text artifacts and executes the machine learned language model. The system may use the output of the machine learned language model to rank a set of text artifacts.

According to one or more embodiments, the system removes one or more text artifacts from the set of text artifacts according to a selection rule. An example of a selection rule is to remove text artifacts whose performance is below a threshold value and add one or more text artifacts to the set of text artifacts if the performance of each of the text artifacts is above a threshold value.

### BRIEF DESCRIPTION OF THE DRAWINGS

FIG. 1A illustrates an example system environment for an online system 140, in accordance with one or more embodiments.

FIG. 1B illustrates an example system environment for an online system 140, in accordance with one or more embodiments.

FIG. 2A illustrates an example system architecture for an online system 140, in accordance with one or more embodiments.

FIG. 2B shows an example of a text artifact generated by a content generation module according to one or more embodiments.

FIG. 3 illustrates the interactions of a content testing system with a content provider system such as the online system, according to one or more embodiments.

FIG. 4 shows a system for querying a machine learned language model using a specific prompt, according to one or more embodiments.

FIG. 5 illustrates the various components of the system and their interactions according to one or more embodiments.

FIG. 6 illustrates the process executed by the artifact selection module to generate text artifacts according to one or more embodiments.

FIG. 7 shows the flow of a process for generating prompts for the LLM according to one or more embodiments.

### DETAILED DESCRIPTION

An online system generates textual artifacts. The textual artifacts may be provided to a search engine for displaying with search engine results. The textual artifacts may promote products or services of an enterprise. The online system continuously tracks the performance of individual textual artifact variants. The online system periodically replaces a subset of the currently tested textual artifact variants with textual artifact determined to have better performance. The replacement policy implements explore & exploit logic based on reinforcement learning to trade off benefits of trying new textual artifact variants against the cost of potentially testing out inferior textual artifact variants.

The online system feeds the performance of previously tested textual artifact variants into a machine learned language model, for example, a large language model (LLM) to generate new variants to test. A machine learned language model is also referred to herein as a machine learning based language model or machine learned language model. The online system uses a specifically designed prompt that requests the machine learned language model to generate new textual artifact variants that have high performance. The prompt provided as input to the machine learned language model for generating text artifacts is updated based on the performance of prior prompts. The online system may also be referred to herein as a system. Although embodiments are described in terms of an online system, the techniques disclosed may also be applied in systems that are not online, i.e., systems that work in offline mode.

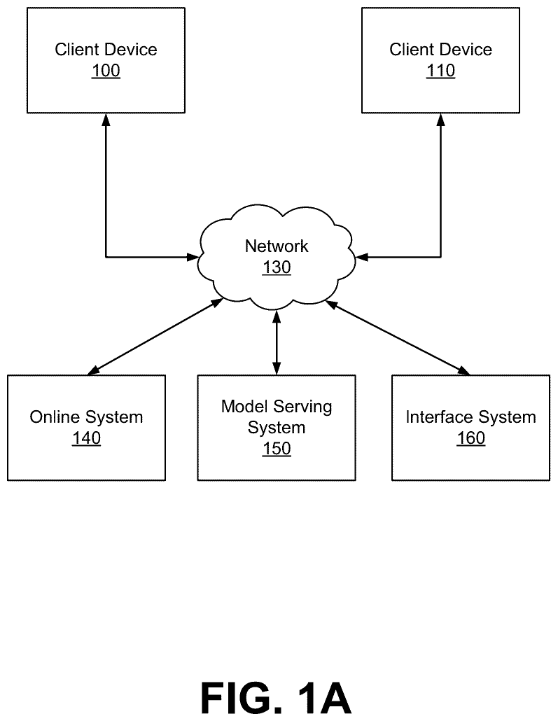

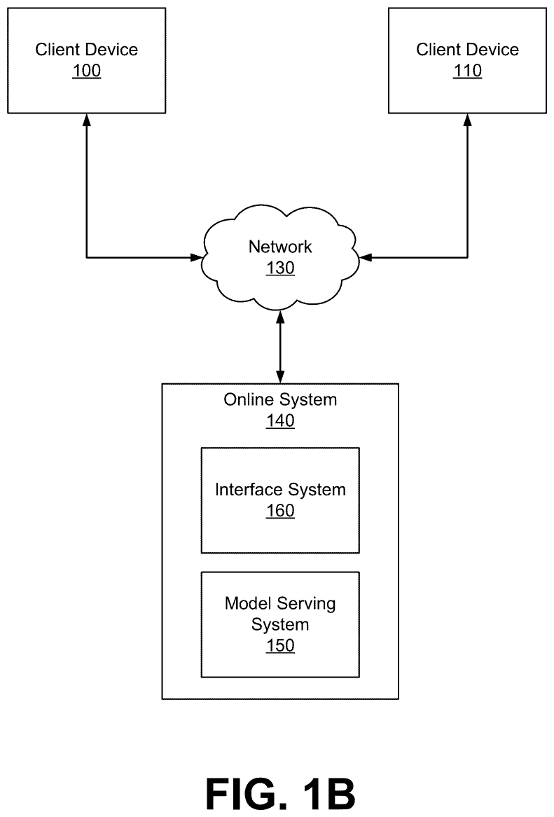

FIG. 1A illustrates an example system environment for an online system 140, in accordance with one or more embodiments. The system environment illustrated in FIG. 1A includes client devices 100, 110, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention. Additionally, any number of client devices may interact with the online system 140.

The client device 100 is a client device through which a user may interact with another client device 110, or the online system 140. The client device 100 can be a personal or mobile computing device, such as a smartphone, a tablet, a laptop computer, or desktop computer. In some embodiments, the client device 100 executes a client application that uses an application programming interface (API) to communicate with the online system 140.

A user uses the client device 100 to interact with the online system 140. The client device 100 presents a user interface that allows the user to perform actions such as performing searches with the online system 140. The user interface may be part of a client application operating on the client device 100. The user interface allows the user to search for items that are available through the online system 140.

Additionally, the client device 100 includes a communication interface that allows a user to communicate with other users. This communication interface allows the user to input a text-based message to transmit to the client device 110 via the network 130. The client device 110 receives the message from the client device 100 and presents the message to the user of the client device 110. The client device 110 also includes a communication interface that allows the user to communicate with other users. The client device 110 transmits a message provided by the user to the client device 100 via the network 130. In some embodiments, messages sent between the client device 100 and the client device 110 are transmitted through the online system 140. In addition to text messages, the communication interfaces of the client device 100 and the client device 110 may allow the users to communicate through audio or video communications, such as a phone call, a voice-over-IP call, or a video call.

The client device 110 is a client device through which a user may interact with other client devices 100, or the online system 140. The client device 110 can be a personal or mobile computing device, such as a smartphone, a tablet, a laptop computer, or desktop computer. In some embodiments, the client device 110 executes a client application that uses an application programming interface (API) to communicate with the online system 140.

The client devices 100, 110, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLMs, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the online system 140 collects comments from multiple users. The online system 140 receives and processes queries based on the comments. Specifically, the online system 140 prepares one or more prompts for input to the model serving system 150 based on the user queries. The online system 140 receives a response to the prompt from the model serving system 150 based on execution of the machine-learned model using the prompt. The online system 140 obtains the response and provides the requested information to the user.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

In one or more embodiments, the online system 140 is connected to the interface system 160. As noted above, the interface system 160 may interact with users using natural language text to receive user comments. The interface system 160 receives external data from the online system 140 (for example, user comments) and builds a structured index over the external data using, for example, another machine-learned language model or heuristics.

The interface system 160 obtains one or more responses from the model serving system 150 and synthesizes a response to the query on the external data. While the online system 140 can generate a prompt for a machine learned language model using the external data as context, the amount of information in the external data may exceed prompt size limitations of the machine-learned language model. The interface system 160 resolves prompt size limitations by generating a structured index of the data. The interface system 160 also offers data connectors to external data sources.

The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of information obtained from the index as contextual information for the query.

FIG. 1B illustrates an example system environment for an online system 140, in accordance with one or more embodiments. The system environment illustrated in FIG. 1B includes client devices 100, 110, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

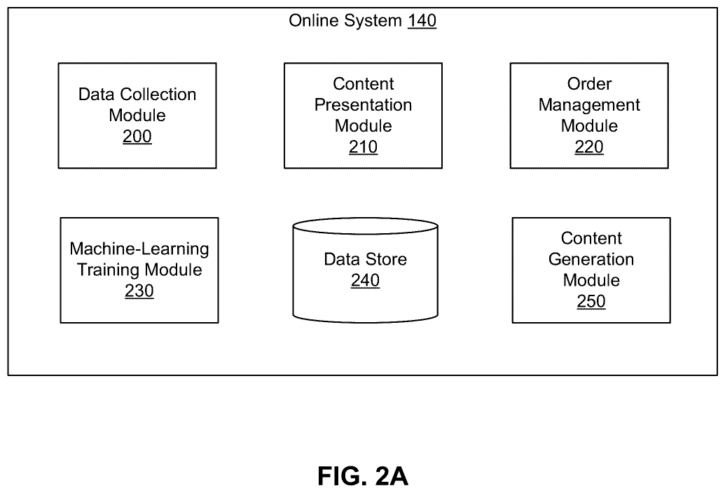

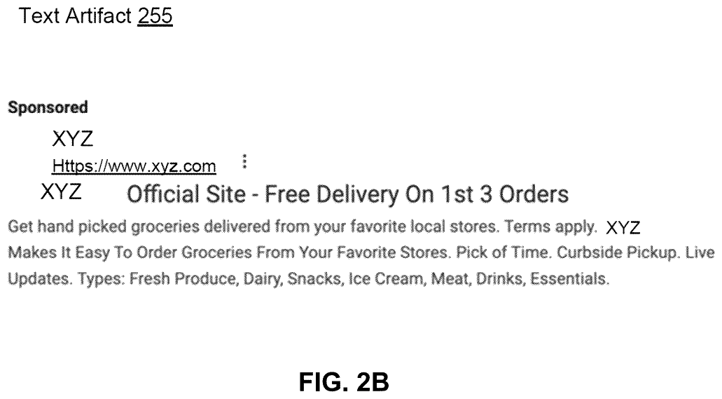

FIG. 2A illustrates an example system architecture for an online system 140, in accordance with one or more embodiments. The system architecture illustrated in FIG. 2A includes a data collection module 200, a content presentation module 210, a machine learning training module 230, a data store 240, and a content generation module 250. Alternative embodiments may include more, fewer, or different components from those illustrated in FIG. 2A, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user. The data collection module 200 may collect the user data from sensors on the client device 100 or based on the user's interactions with the online system 140.

The content presentation module 210 selects content for presentation to a user. In some embodiments, the content presentation module 210 scores items based on a search query received from the client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

The machine learning training module 230 trains machine learning models used by the online system 140. For example, the machine learning training module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine learning training module 230 may further train parameters of the machine-learned model based on data specific to the online system 140 stored in the data store 240. As an example, the machine learning training module 230 may obtain a pre-trained transformer language model and further fine tune the parameters of the transformer model using training data stored in the data store 240. The machine learning training module 230 may provide the model to the model serving system 150 for deployment.

FIG. 2B shows an example text artifact generated by the system, according to one or more embodiments. The text artifact 255 is generated by the machine learned language model and may be provided as a search result for a search engine such as Google™M. The text artifact 255 may be returned as a sponsored search result as part of a search marketing campaign of a content provider.

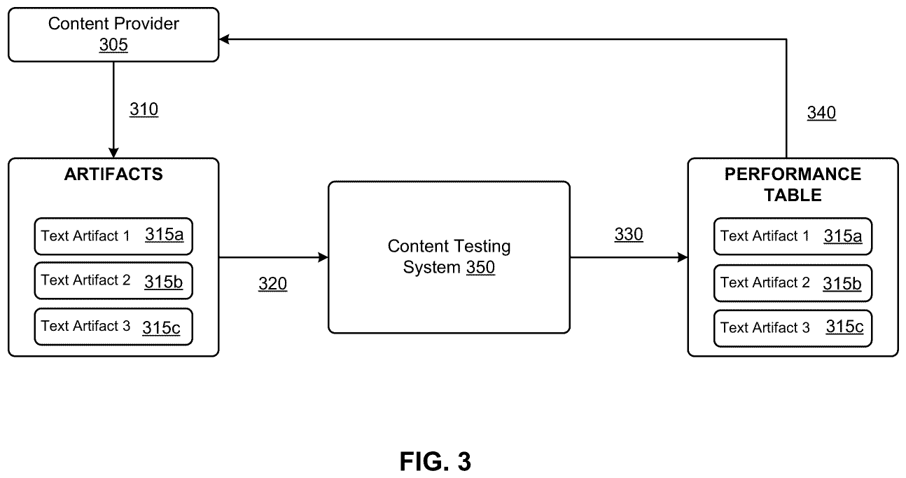

FIG. 3 illustrates the interactions of a content testing system with a content provider system such as the online system, according to one or more embodiments. The content testing system 350 tests different variants of content (e.g., text artifacts) and collects data on their respective performance. Alternative embodiments may include more, fewer, or different modules from those illustrated in FIG. 3. Steps indicated as being performed by a particular module may be performed by other modules than those indicated herein.

In step 310, a content provider 305 (for example, the content generation module 250 of the online system 140) generates a set of textual artifacts, for example 315a, 315b, 315c. These text artifacts can include headlines, descriptions, or other types of textual data that a customer is presented with when exposed to their ads. In step 320, the content provider 305 submits these text artifacts to the content testing system 350.

In step 330, the content testing system runs tests to evaluate the performance of these artifacts. The content testing system 350 returns data on the performance of individual artifacts in the form of a table, where performance is presumed to be a quantitative measure (e.g., number of clicks). Accordingly, the content testing system 350 returns performance metrics for each text artifact to allow comparison of different text artifacts. The performance metric may be determined based on user feedback. For example, the text artifacts may be provided to a set of user who are asked to rank the text artifact based on a quality metric. The feedback provided by the users is aggregated to generate a performance metric. According to an embodiment, different metrics are used to evaluate the text artifacts and a weighted aggregate of the different performance metrics is used for evaluating/ranking the text artifacts. The performance metric may be a number within a range, for example, an integer between 1 and 10 such that higher values indicate higher performance. The performance table includes the text artifacts along with their performance metrics. The performance table may rank the text artifacts based on the performance metrics, for example, sort them in decreasing order of performance.

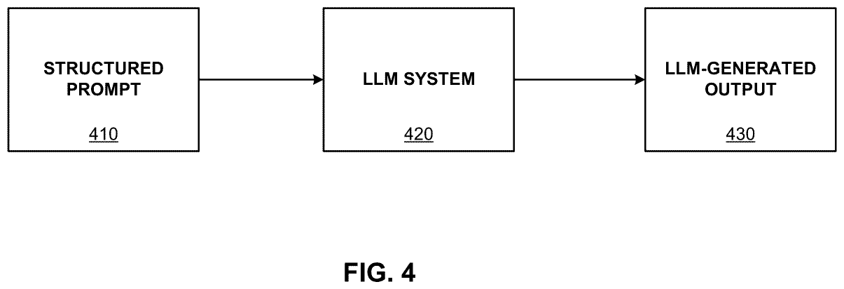

FIG. 4 shows a system for querying a machine learned language model using a specific prompt, according to one or more embodiments. The system comprises a machine learned language model (for example, a large language model or LLM) and is referred to as the LLM system 420. The LLM system 420 can be queried using a structured prompt 410. According to one or more embodiments, the structured prompt 410 includes information about the performance of different text artifacts. The structured prompt 410 requests the LLM to provide recommendations for new text artifacts that resemble well-performing text artifacts but do not resemble the poorly performing text artifacts. Alternatively, the structured prompt 410 may include old prompts along with their performance and ask the system to provide an updated prompt. The LLM system 420 generates output 430 that represents structured prompts generated based on the structured prompt 410.

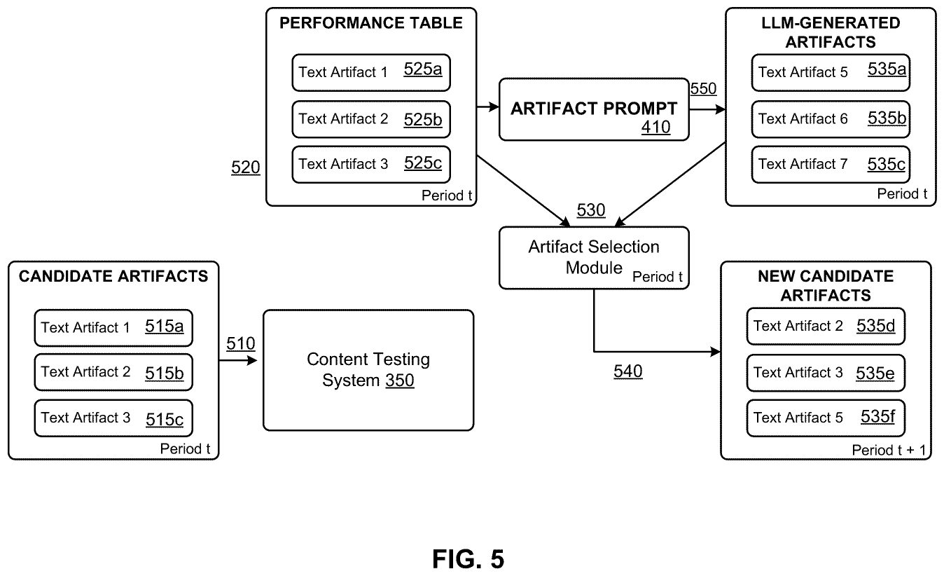

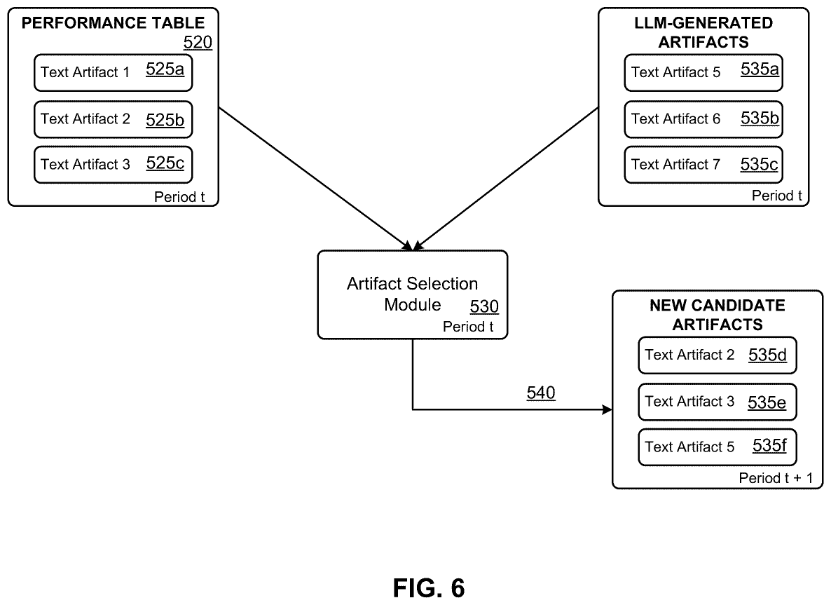

FIG. 5 illustrates the various components of the system and their interactions according to one or more embodiments. Every period t starts with a list of candidate artifacts 515a, 515b, 515c that are provided 510 as input to the content testing system 350. After testing these artifacts, the content testing system 350 returns a performance table 520, including the text artifacts 525a, 525b, 525c alongside a metric that may be a numerical value to describe their performance. Once received the system embeds the performance table 520 into one or more structured prompts 410 that are provided as input to an LLM to generate 550 text artifacts 535a, 535b, 535c. The system collects the LLM-generated output text artifacts 535a, 535b, 535c and combines them with the performance table 520. The system provides the combined information as input to the artifact selection module 530. The artifact selection module 530 returns 540 (i.e., as is described in further detail below with regard to FIG. 6) a new list of text artifacts 535d, 535e, 535f for the next period, t+1. This process is continued for each subsequent time period to generate a new set of candidate text artifacts that are likely to have better performance compared to the set of text artifacts generated during the previous period.

FIG. 6 illustrates the process executed by the artifact selection module to generate text artifacts according to one or more embodiments. Every period t, an artifact selection module 530 combines LLM-generated text artifacts 535a, 535b, 535c with the text artifacts 525a, 525b, 525c and their performance metrics obtained from the performance table 520 to generate a list of new candidate text artifacts 535d, 535e, 535f for the next period t+1.

According to one or more embodiments, the ranking of the text artifacts is generated by the LLM (i.e., the LLM is provided with a prompt asking the LLM to provide a ranked list). According to an embodiment, the system generates the prompt algorithmically from data structures that store information used in the prompt, for example, a list structure storing the text artifacts. The prompt may include examples of previous rankings of text artifacts and request the LLM to generate a ranked list of text artifacts. The prompt may specify a format for the result, for example, an ordered list of text artifacts. The response generated is processed to obtain the ranked list of text artifacts.

According to one or more embodiments, the artifact selection module 530 comprises rules according to which the text artifact generation process selects new candidate text artifacts for experimentation in the next period. The artifact selection module 530 may select the new candidate text artifacts based on performance of prior candidate text artifacts and the list of candidate text artifacts generated by the LLM.

According to an embodiment, the text artifacts are evaluated using a machine learning based model trained to receive as input a text artifact and output a score indicating a quality of the text artifact. The machine learning based model is trained using training data comprising labels generated by users. For example, text artifacts may be presented to users via a user interface that allows the users to accept the text artifact if the text artifact is high quality and reject the text artifact if the text artifact is low quality. The machine learning based model is trained by minimizing a loss function and performing back propagation to adjust the weights of the parameters of the machine learning based model.

According to one or more embodiments, the artifact selection module 530 implements reinforcement learning and implements tradeoffs between exploration and exploitation. For example, the artifact selection module 530 may implement a greedy policy that eliminates the bottom N performing text artifacts in every period and replaces them with the top N candidate text artifacts generated by the LLM.

Accordingly, the artifact selection module 530 replaces a subset of text artifacts with a set of new text artifacts generated by the machine learned language model. The subset of text artifacts replaced are the lowest performing artifacts and the set of new text artifacts are the best performing text artifacts generated by the machine learned language model. The size N of the subset of text artifacts replaced is determined based on an aggregate measure of performance of the text artifacts generated by the machine learned language model.

For example, N represents a parameter that is determined based on the recent success of newly added candidate text artifacts. For example, the system determines the value of N to be higher if recent new artifacts generated by the LLM have higher performance metric compared to previously generated text artifacts and therefore have been particularly successful relative to prior artifacts. The artifact selection module 530 may implement selection functions based on bandit strategies or contextual bandit strategies.

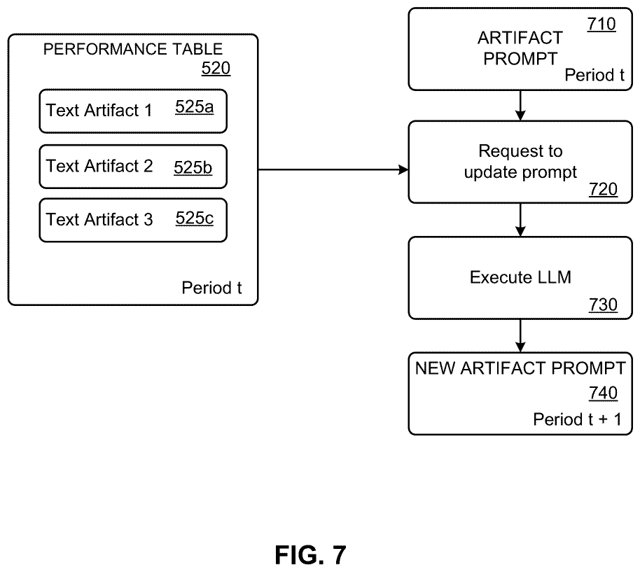

FIG. 7 shows the flow of a process for generating prompts for the LLM according to one or more embodiments. At regular cadence (i.e., every period), the LLM is presented with data on the performance of the text artifacts previously created along with the prompt 710 that was used to generate them. The performance information is obtained from the performance table 520. The prompt is provided to the LLM to execute 730 the LLM. The LLM is asked to use this information to update the prompt with the objective of generating a new prompt 740 that is more likely to generate better performing artifacts.

The artifact selection module 530 uses artifact selection functions that explicitly control the amount of exploration done by the system. The more conservative the selection function, the less the system experiments with new artifacts. The system may be designed to use this feature to let an algorithm explore more during the early stages of an ads campaign but reduce experimentation as the ad campaign matures.

According to one or more embodiments, the system tests the newly generated prompts against old prompts and potential alternatives across different campaigns. The results of these tests are provided as input to the LLM as additional context describing which types of prompts perform better to guide the LLM in the generation of improved prompts.

An expert user may manually edit the prompts or text artifacts to ensure that an ad campaign stays within certain parameters. For example, if an ad campaign is expected to have a particular theme (e.g., “Christmas feel”), the expert user may intervene if the prompt or the text artifacts deviate from that theme.

The system considers contextual information. For example, the process executed by the system can be localized and generate text artifacts suitable for a particular geographical region (or a specific demographics of users) that can be used as a targeting criterion for publishing content items to users. The text artifacts may be generated based on demographic information. Accordingly, users having matching demographic information may be provided the same text artifacts and users with different demographic information may be provided different text artifacts. For example, the text artifacts generated may be different for one state (e.g., Texas) compared to text artifacts generated for a different state (e.g., California). Similarly, text artifacts generated for a particular age group of users may be different compared to a different age group. Similarly, text artifacts generated for a male users may be different from text artifacts generated for female users. The system may be configured to generate text artifacts for different granularity of user groups depending on the user groups selected for targeting.

According to an embodiment, the text artifacts generated are presented to users that provide feedback on the quality of the text artifacts. For example, a user may accept the text artifact indicating the text artifact has a quality above a threshold value. Alternatively, a user may reject the text artifact indicating the text artifact has a quality below a threshold value. According to an embodiment, the system uses the feedback to fine tune the machine learned language model. According to an embodiment, system modifies the prompts provided to the machine learned language model based on the user feedback so as to improve the chances of generating higher quality text artifacts. For example, the prompt may provide good and bad examples of text artifacts. Accordingly, text artifacts accepted by users are provided as examples of good text artifacts and text artifacts rejected by users are provided as examples of bad text artifacts.

### Applications

Techniques disclosed herein may be used for content items that are predominantly based on text. A content item may be a sponsored content item, for example, an advertisement that is presented by the online system to users of the online system on behalf of a content provider system (e.g., an advertiser). Accordingly, the content provider system provides remuneration to the online system for distributing the content item. The remuneration for a content item may be determined based on various criteria, for example, the size of the content item, the position within a user interface (e.g., search engine results) at which the content item is presented, the time at which the content item is presented to a user, and so on. According to one or more embodiments, the content provider system provides remuneration for each instance of display of the content item to a user by the online system, also referred to as an impression.

The techniques disclosed herein may be used for search engine marketing (SEM). SEM constitutes a significant way for content providers such as enterprises to advertise their products and services online. To develop successful campaigns, content providers typically evaluate the performance of many distinct content variants that differ along a multitude of dimensions. For SEM on Google™M, for example, advertisers will typically evaluate different headlines (“Instacart (R) Official Site-Free Delivery On 1st 3 Orders”) or descriptions (“Get hand picked . . . [ . . . ]”).

Generating such textual artifacts to test for a given campaign is typically performed by dedicated teams. Platforms such as Google™M provide tools to facilitate this process. The development of suitable text artifacts significantly impacts the success of SEM campaigns. The system disclosed according to one or more embodiments dynamically optimizes SEM campaigns using a combination of reinforcement learning and generative AI. The system can be executed either as part of a content distribution platform (e.g., by a platform that hosts a search engine) or on behalf of the customer of such a content distribution platform. The system disclosed improves the efficiency of the process for generating textual artifacts. Text artifacts generated by conventional techniques are typically lower quality and may not be suitable for a specific purpose, for example, an SEM campaign. As a result, these text artifacts are rejected by either a human expert or any automated evaluation mechanism, for example, a model that generates a metric evaluating the suitability or quality of text artifacts. As a result, significant amounts of resources are utilized in generating more text artifacts than are needed. This results in waste of computational and developer resources. In contrast, the system according to one or more embodiments generates higher quality and suitable text artifacts that are more likely to get accepted, thereby conserving computational resources and improving the computational efficiency of the overall process. Accordingly, the text artifacts generating mechanism provides a technical improvement over conventional techniques by generating higher quality text artifacts that are suitable for a specific task such as an SEM campaign.

The system disclosed may be used to generate text-based content items in a process comprising following steps. In step 1, the online system runs an A/B test on an ecommerce platform that tests text artifacts (e.g., by varying a subheading or a message during checkout). In step 2, the online system feeds a machine learned language model (e.g., an LLM) with the results of the A/B tests and requests the machine learned language model to generate new variants that resemble the winning variant. In step 3, the online system loops back to step 1, integrates the new variant into a new test, and repeats the process until some stopping criterion is reached.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
receiving, by a computer processor, a prompt for a machine learned language model, the prompt configured to request the machine learned language model to generate text artifacts;
executing, by the computer processor, the machine learned language model using the prompt to generate a set of text artifacts;
evaluating, by the computer processor, each of the set of text artifacts to identify performance of each of the set of text artifacts;
iteratively improving the set of text artifacts by performing a set of steps comprising:
updating, by the computer processor, the prompt based on the performance of each of the set of text artifacts to obtain a new prompt;
executing, using the new prompt, the machine learned language model to generate a new set of text artifacts; and
evaluating, by the computer processor, the new set of text artifacts to identify performance of each of the new set of text artifacts; and
transmitting text artifacts from the set of text artifacts to a search engine for storing, wherein the search engine provides the text artifacts to users along with search results returned in response to search queries processed by the search engine.

2. The method of claim 1, wherein the prompt is a first prompt, and wherein evaluating the new set of text artifacts to identify performance of each of the new set of text artifacts comprises:
generating a second prompt requesting the machine learned language model to identify performance of each of the new set of text artifacts; and
executing the machine learned language model using the second prompt to identify performance of each of the new set of text artifacts.

3. The method of claim 1, further comprising:
for each of the set of text artifacts, determining a performance metric by executing a machine learning based language model trained to receive a text artifact as input and output a score indicating a performance of the text artifact.

4. The method of claim 1, further comprising:
for each of the set of text artifacts, comparing a performance metric of the text artifact with a threshold value.

5. The method of claim 4, further comprising:
removing one or more text artifacts from the new set of text artifacts responsive to identifying that the performance of each of the one or more text artifacts is below a threshold value.

6. The method of claim 4, further comprising:
adding one or more text artifacts to the new set of text artifacts responsive to identifying that the performance of each of the one or more text artifacts is at least a threshold value.

7. The method of claim 1, further comprising:
replacing a subset of text artifacts from the new set of text artifacts with a set of new text artifacts generated by the machine learned language model, wherein the subset of text artifacts replaced are lowest performing artifacts of the new set of text artifacts and the set of new text artifacts are best performing text artifacts generated by the machine learned language model.

8. The method of claim 7, wherein a size of the subset of text artifacts replaced is identified based on an aggregate measure of performance of the text artifacts generated by the machine learned language model.

9. The method of claim 1, wherein transmitting one or more text artifacts from the set of text artifacts for display via a client device comprises:
providing text artifacts from the new set of text artifacts to a search engine for providing to users along with search results returned in response to search queries processed by the search engine.

10. A non-transitory computer readable storage medium storing instructions that when executed by one or more computer processors cause the one or more computer processors to perform steps comprising:
receiving, by a computer processor, a prompt for a machine learned language model, the prompt configured to request the machine learned language model to generate text artifacts;
executing, by the computer processor, the machine learned language model using the prompt to generate a set of text artifacts;
evaluating, by the computer processor, each of the set of text artifacts to identify performance of each of the set of text artifacts;
iteratively improving the set of text artifacts by performing a set of steps comprising:
updating, by the computer processor, the prompt based on the performance of each of the set of text artifacts to obtain a new prompt;
executing, using the new prompt, the machine learned language model to generate a new set of text artifacts; and
evaluating, by the computer processor, the new set of text artifacts to identify performance of each of the new set of text artifacts; and
transmitting text artifacts from the set of text artifacts to a search engine for storing, wherein the search engine provides the text artifacts to users along with search results returned in response to search queries processed by the search engine.

11. The non-transitory computer readable storage medium of claim 10, wherein the prompt is a first prompt, and wherein evaluating the new set of text artifacts to determine performance of each of the new set of text artifacts comprises:
generating a second prompt requesting the machine learned language model to identify performance of each of the new set of text artifacts; and
executing the machine learned language model using the second prompt to identify performance of each of the new set of text artifacts.

12. The non-transitory computer readable storage medium of claim 10, wherein the instructions further cause the one or more computer processors to perform steps comprising:
for each of the set of text artifacts, determining a performance metric by executing a machine learning based language model trained to receive a text artifact as input and output a score indicating a performance of the text artifact.

13. The non-transitory computer readable storage medium of claim 10, wherein the instructions further cause the one or more computer processors to perform steps comprising:
for each of the set of text artifacts, comparing a performance metric of the text artifact with a threshold value.

14. The non-transitory computer readable storage medium of claim 13, wherein the instructions further cause the one or more computer processors to perform steps comprising:
removing one or more text artifacts from the new set of text artifacts responsive to identifying that the performance of each of the one or more text artifacts is below a threshold value.

15. The non-transitory computer readable storage medium of claim 13, wherein the instructions further cause the one or more computer processors to perform steps comprising:
adding one or more text artifacts to the new set of text artifacts responsive to identifying that the performance of each of the one or more text artifacts is at least a threshold value.

16. The non-transitory computer readable storage medium of claim 10, wherein the instructions further cause the one or more computer processors to perform steps comprising:
replacing a subset of text artifacts from the new set of text artifacts with a set of new text artifacts generated by the machine learned language model, wherein the subset of text artifacts replaced are lowest performing artifacts of the new set of text artifacts and the set of new text artifacts are best performing text artifacts generated by the machine learned language model.

17. The non-transitory computer readable storage medium of claim 16, wherein a size of the subset of text artifacts replaced is determined based on an aggregate measure of performance of the text artifacts generated by the machine learned language model.

18. The non-transitory computer readable storage medium of claim 10, wherein the instructions further cause the one or more computer processors to perform steps comprising:
providing text artifacts from the new set of text artifacts to a search engine for providing to users along with search results returned in response to search queries processed by the search engine.

19. A computer system comprising:
one or more computer processors; and
a non-transitory computer readable storage medium storing instructions that when executed by one or more computer processors cause the one or more computer processors to perform steps comprising:
receiving, by a computer processor, a prompt for a machine learned language model, the prompt configured to request the machine learned language model to generate text artifacts;
executing, by the computer processor, the machine learned language model using the prompt to generate a set of text artifacts;
evaluating, by the computer processor, each of the set of text artifacts to identify performance of each of the set of text artifacts;
iteratively improving the set of text artifacts by performing a set of steps comprising:
updating, by the computer processor, the prompt based on the performance of each of the set of text artifacts to obtain a new prompt;
executing, using the new prompt, the machine learned language model to generate a new set of text artifacts; and
evaluating, by the computer processor, the new set of text artifacts to identify performance of each of the new set of text artifacts; and
transmitting text artifacts from the set of text artifacts to a search engine for storing, wherein the search engine provides the text artifacts to users along with search results returned in response to search queries processed by the search engine.

20. The computer system of claim 19, wherein the prompt is a first prompt, and wherein evaluating the new set of text artifacts to determine performance of each of the new set of text artifacts comprises:
generating a second prompt requesting the machine learned language model to determining performance of each of the new set of text artifacts; and
executing the machine learned language model using the second prompt to determine performance of each of the new set of text artifacts.
